(19) United States
(12) Patent Application Publication
(10) Pub. No.: US 2011/0302021 A1
(43) Pub. Date: Dec. 8, 2011

(54) FUNDRAISING PROCESS USING POS TECHNOLOGY

(76) Inventors: Christopher S. Reid, Sachse, TX (US); Brian S. Plotkin, Plano, TX (US)

(21) Appl. No.: 12/796,055

(22) Filed: Jun. 8, 2010

(51) Int. Cl. G06Q 30/00; G06Q 50/00; H04L 9/32; G06Q 40/00; G07F 7/08; G06Q 10/00; G06Q 20/00

(52) U.S. Cl. 705/14.35; 705/14.38; 726/29

(57) ABSTRACT

The present invention provides a system that allows merchants to donate a portion of each sale to every customer participating in the discount program directly to the fundraiser chosen by the customer. Customers are incentivized to use the card at participating merchants because the discounts received from using the card can be significantly greater than the initial cost of the card. The system of the invention can be implemented on a card that can serve the dual purpose of being a discount card as well as a number of other cards utilized by customers. By having more than one function for the card, customers are encouraged to utilize the discount feature more routinely because of the convenience of carrying one card with multiple functions.

### BACKGROUND OF THE INVENTION

Providing incentives to customers and companies to donate money to a charitable organization has been a challenge to charitable organizations for many years. Those charitable organizations that are successful at providing such incentives are able to raise money for the organization that would not have been possible otherwise.

One of the incentives that has been provided in the past is to give the person who contributes funds to the organization a discount card that can be used to receive a discount from participating merchants. This method has been improved upon by not only allowing the organization to earn money from the sale of the cards, but also by setting up a system whereby the merchant agrees to set aside a portion of every sale using the discount card to be paid indirectly to the organization.

Most fund raising today involves selling something (cookies, car washes, magazines, popcorn, etc.). The item being sold is either given to the fundraising entity free or provided at cost. It is then sold to the customer at or near MSRP where the fundraising entity keeps the difference. This typically results in a net gain to the fundraiser of anywhere between 20% and 80%. It would be desirable to increase the percentage net gain to the fundraiser. It would also be desirable to provide a system for increasing the net gain to the fundraiser without increasing the overhead or requiring large capital expenditures by the fundraisers.

Finally, it would be desirable to provide a card that can serve as a discount card for a fundraising entity as well as other cards used by a customer so that the customer need not carry a separate card to take advantage of the discount program. Providing a multi-function card system to retailers at no charge other than the cost of providing discounts on sales would result in retailers welcoming the system, and in combination with making a single card available to the customer for multiple purposes, would result in a proliferation in the use of such discount cards. The cost of the cards to consumers can be minimal compared to what they will save in the form of discounts.

### SUMMARY OF THE INVENTION

The present invention overcomes the problems with the prior art by providing a system that allows merchants to donate a portion of each sale to every customer participating in the discount program directly to the fundraiser chosen by the customer. Customers are incentivized to use the card at participating merchants because the discounts received from using the card can be significantly greater than the initial cost of the card. By contributing a percentage of each sale directly to a charitable entity recognized by the IRS, the merchants receive a tax deduction for their contributions that would not be realized if the contribution had been made first to an non-exempt third party. By participating in the program, merchants effectively receive promotions at the cost of providing a discount on products sold to the participating customers. Thus, the program is an effective advertising program in that it does not cost anything to the vendor unless the vendor makes a sale.

In one embodiment of the invention, the system of the invention can be implemented on a card that can serve the dual purpose of being a discount card as well as a number of other cards utilized by customers. For example, in addition to the discount card information, the card could contain all of the information necessary for the card to be used as a credit/debit card, a hotel room key, a gas card or other loyalty card, a rewards card, a medical records key, etc. By having more than one function for the card, customers are encouraged to utilize the discount feature more routinely because of the convenience of carrying one card with multiple functions.

In short, retailers and consumers alike have significant incentives to use the program of the present invention because retailers acquire more business, consumers save money, and fundraisers raise more money without the expense of the overhead associated with implementing a discount program. The consumer does nothing but use his or her card normally to make purchase transaction, and the discount can be automatically applied to a sale by a participating retailer.

### BRIEF DESCRIPTION OF THE DRAWINGS

FIG. 1 is a diagram of a fundraising system in accordance with an embodiment of the invention.

FIG. 2 is a diagram of a fundraising system in accordance with an alternative embodiment of the present invention.

FIG. 3 is a diagram of an alternative embodiment of the present invention showing multiple uses of a single card held by a consumer.

FIG. 4 is a diagram of an alternative embodiment of the present invention showing the implementation of a medical records key on a card held by a consumer.

FIG. 5 is a flowchart showing a process for utilizing a smart phone as a POS port in accordance with an alternative embodiment of the present invention.

### DETAILED DESCRIPTION

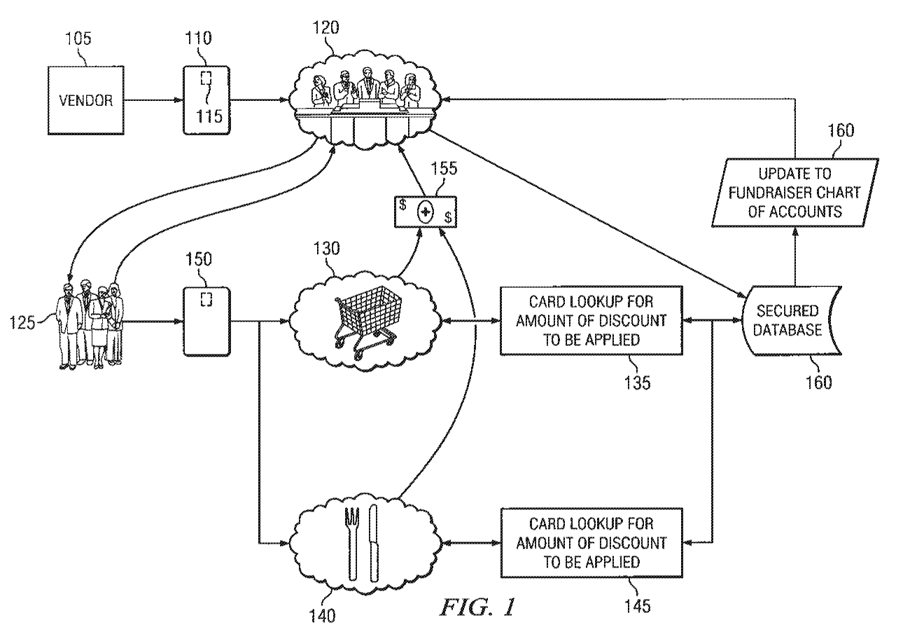

Referring now to FIG. 1, a diagram of a fundraising system in accordance with an embodiment of the invention is illustrated. In this embodiment, a vendor 105 in the business of providing infrastructure to charities and fundraisers provides a set of forms and blank cards 110 to the fundraiser 120. The cards 110 may be preprinted with the fundraiser's logo 115 and may be in the form of a magnetic swipe card, a smart card, a card embedded with an RFID chip, a card imprinted with a bar code, a combination of those items, or some other format that is now available or may be available in the future.

The fundraising entity 120 then sells these cards to their customers 125. The customer fills out the form, pays the money, and is given a card or sent a card depending on the level of personalization. The fundraising entity 120 then fills out the form, entering all the appropriate information (via an electronic transfer of information) to the vendor 105. The card can be activated upon receipt of the information by the vendor or in any other manner known in the art. Alternatively, an online website address may be provided to the customers 125 so that the customer may go to the vendor's website to enter the appropriate information to activate the card. In one embodiment of the invention, half of the cost of the card to the customer goes to the fundraising entity and the other half goes to the vendor to cover expenses.

In one embodiment, by purchasing the cards 150 the customers 125 are allowed a predetermined fixed amount of discounts at participating merchants 130, 140. For example, the fundraiser 120 can sell $10 cards that give the customers 125 $50 worth of discounts. Once those $50 worth of discounts have been exhausted, the card 150 no longer grants additional discounts unless the customer renews the card. There is no minimum lifespan for the card and it may be renewed indefinitely. In one embodiment, the cardholder commits to the fundraiser from which he or she bought the card for a certain period, such as one year. In an alternative embodiment, a percentage discount can be applied to each transaction with a participating merchant for a certain period of time.

Once the fundraiser starts, the fundraising entity 120 can be given access to the vendor's servers 160 (via a web site or other format). This allows the fundraising entity 120 to see who their participants are, how much money has been raised both by the direct sales of the cards and from the participating merchants, and which cards' funds are depleted.

When the customer goes to a participating merchant 130, 140 (restaurant, retailer, wholesaler, etc.) and purchases an item, the customer's card 150 is processed through the merchant's “point of sale” (POS) machine prior to swiping a credit card or other form of payment. The results of this action will instruct the merchant 130, 140 as to the dollar amount of the discount 135, 145 the merchant should give the customer for the purchase. The discount is then applied to the bill and then the difference is paid by the customer. By agreeing to participate, the merchants 130, 140 agree to contribute the amount of the respective discounts 135, 145 to the fundraising entity 120 in the form of charitable donations 155. The amounts owed to the fundraising entity can be tabulated in the vendor's database 160 and submitted directly by the merchants 130, 140 to the fundraising entity 120 on a monthly basis. A monthly invoice can be sent by the vendor 105 to the merchants 130, 140 detailing how much was given in discounts and how much merchant owes to the associated fundraiser.

The merchants 130, 140 can also be given access to the vendor's servers 160 via the vendor's website to allow the merchants 130, 140 the option of creating a variety of reports detailing various data collected. These reports can include how much they have given out in actual cash discounts, how much they have paid in tax deductable donations 155, how much in purchases they have generated from customers 125 and more.

The customers 125 may also be given access to the vendor's web site so that they can see exactly how much money has been contributed to the fundraising entity 120. Additionally, the customers 125 can determine how much money is left in discounts, what merchants 130, 140 participate (as well as link to their websites), and can renew their cards 150 if so desired. Finally, the customers 125 can change their choice of fundraising entity at the start of the second year.

The system described above encourages merchants 130, 140 to participate in the program by providing tax incentives as well as advertising benefits. Being a participant gives a merchant a means for participating in local fundraisers 120 without just handing over a check. Participation provides advertising to the merchant and adds traffic to the vendor's place of business. The vendor has the added incentive of enabling the portion of the discount granted to the customer to be treated as a tax deductible donation as allowed by the IRS. Although FIG. 1 shows only one fundraiser, multiple fundraisers can participated with vendor 105, thus capitalizing on the economies of scale realized by the vendor 105 to reduce the expense of the infrastructure necessary to implement the program.

The vendor 105 provides the technology and infrastructure that is responsible for collecting the data and funds. The vendor 105 can also be responsible for signing up merchants 130, 140 to participate in the program. This creates efficiency in that the merchant need only be signed up once to participate with the vendor. Thus, the vendor can get the agreement of merchants and consequently obtain agreement by the merchant to participate in any fundraising event facilitated by vendor under conditions agreeable to the merchant and the vendor. By taking responsibility for implementing the program, the vendor helps the fundraisers save money on the overhead that would be necessary for the fundraising entity to implement its own program. Economies of scale are also realized by allowing the vendor to serve multiple fundraisers with the same merchants 130, 140.

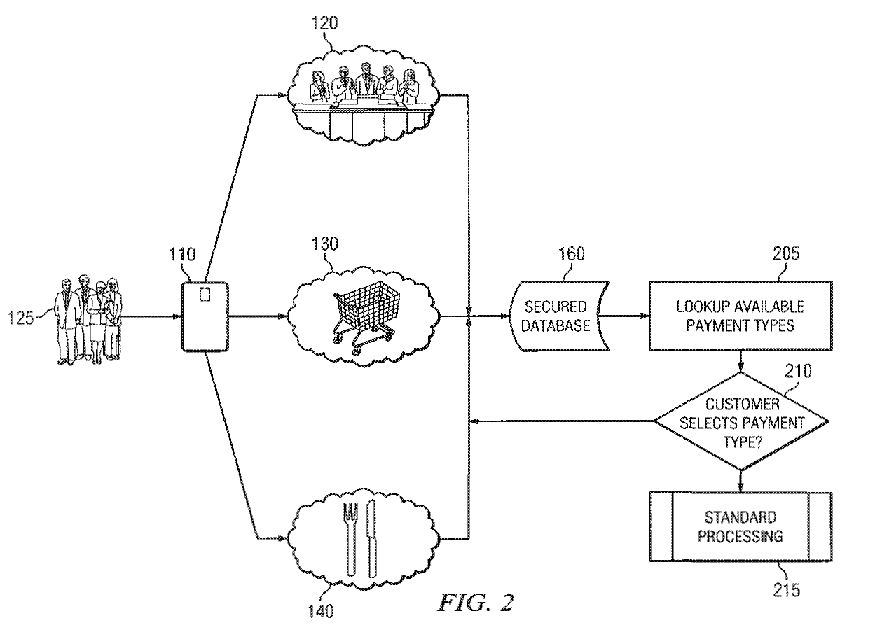

Referring now to FIG. 2, an alternative embodiment of the present invention is illustrated. The invention operates generally in the same way as the invention described above with reference to FIG. 1. However, instead of requiring the customers 125 to submit another card as payment for the discounted transaction, the card 110 may also grant access to the customer's credit card or debit card information such that when the card is processed, the POS system causes the vendor's server 160 to look up the available payment options 205 and allows the customer to select 210 via the POS system a choice of payment options—e.g., Visa, Mastercard, American Express, debit card, or other forms of electronic payment that can be conducted over today's POS systems of other processing systems yet to be developed. In this manner, the customers 125 can add certain payment methods via a connection to the vendor's server. Alternatively, the forms of payments available may be stored on and retrieved directly from the card 110 by the POS system. Once the payment information is received, the payment for the transaction is processed in the normal manner 215.

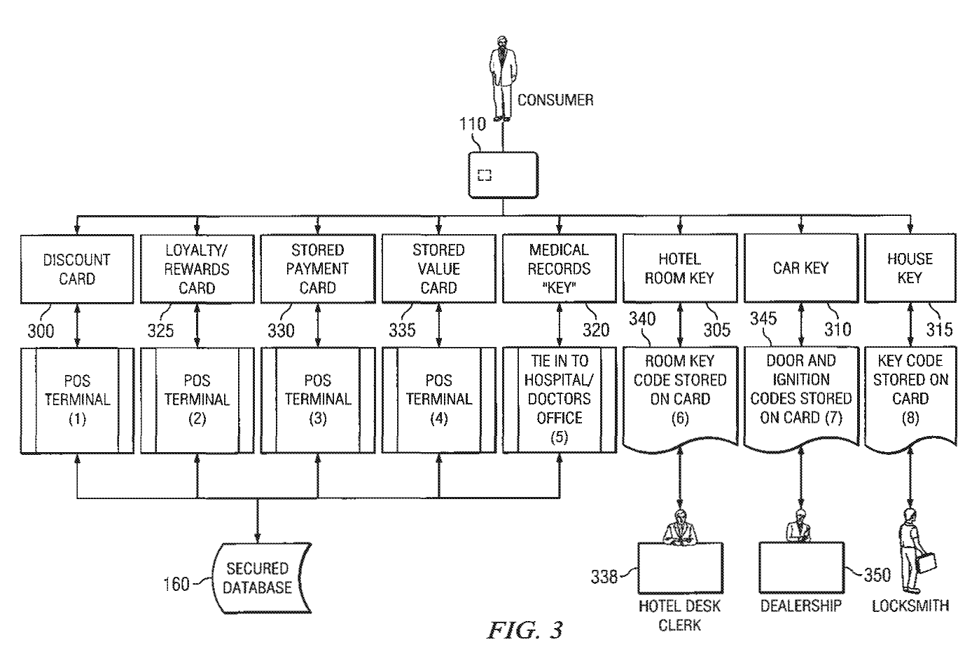

Referring now to FIG. 3, a diagram showing an alternative embodiment of the present invention is illustrated. There are a number of other uses for which the card 110 may be utilized to prevent the customer from having to carry multiple cards, thereby encouraging the use of the fundraising discount feature 300 of the card. For example, the card 110 could be used as a hotel key 305, car key 310, house key 315, medical records key 320, loyalty/rewards card 325, stored payment card 330 and stored value card 335.

For example, upon checking in at a hotel, the card 110 is provided to the desk clerk 338, and the desk clerk 338 uploads the door code information 340 to the card 110. The card 110 could be used in a similar manner as a home key 315 or office door key. To be used as a car key 310, the card is presented to the dealership 350 where the car is purchased and the car's ignition system information is stored 345 on the card 110. The card 110 could be used as a medical records key 320 to allow access to certain secure information on a computer server. The card 110 may also contain the myriad of loyalty cards that the typical person utilizes. Instead of having to carry multiple individual loyalty cards, all pertinent data may be contained on one card 110. Thus, when the user makes a payment at a merchant that accepts loyalty cards, the user may present the card 110 and the loyalty storage mechanisms will update as if the merchant's original loyalty card had been presented.

To accommodate the various alternative uses of the card described above, the card would need to be compatible with the alternative use. For example, to be used as a car key 310, the car's ignition system could utilize a smart card reader. Alternatively, an RFID chip can be embedded into the card 110 to act as a replacement for the key fobs currently available today for many cars having push-to-start ignition systems.

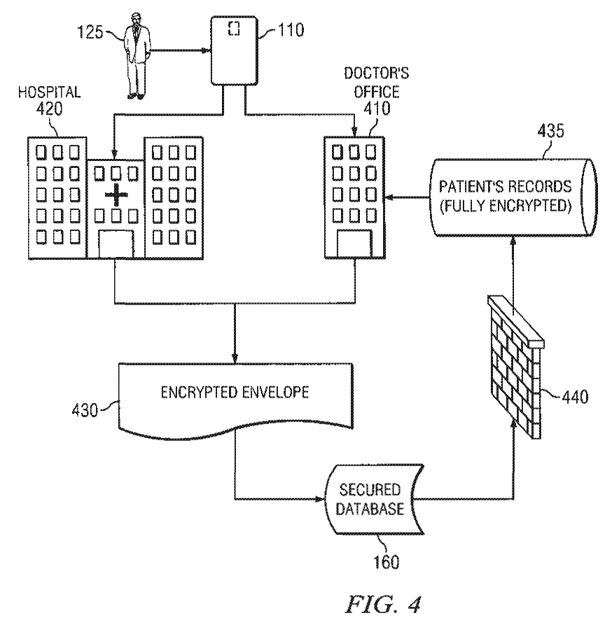

Referring now to FIG. 4, a diagram showing the implementation of a medical records key in accordance with an embodiment of the present invention is illustrated. To allow access to medical records, a biometric print (usually in the form of a fingerprint but could also be in the form of an iris scan, retinal scan, hand print, earlobe print, or any other viable biometric identity) can be stored on the card 110. The biometric print, along with a password known by the customer 125, create a unique encryption key. This key is used to encrypt and decrypt the medical records. The medical records can be stored, in their encrypted format on the vendor's servers 160. To protect the confidentiality of the customer's records, the only identifying information is an encrypted identifier. This identifier can be created in advance using the biometric print and the customer's password. Using an encrypted identifier in this manner to identify the medical records ensures total anonymity of the encrypted records to all vendor personnel.

When the customer goes to the doctor 410 or the hospital 420, the card 110 is processed by a reader. The reader prompts the customer 125 to enter his or her password and a biometric print is obtained from the customer 125. These items are combined to create an encryption key 430 that is sent to the vendor's servers 160 where a lookup is performed to match the encryption key with the previously created encrypted identifier. Once a match is found, the customer's encrypted records 435 are downloaded to the health care provider's systems through a virtual tunnel 440. The health care provider can then decrypt the medical records using the encryption key. As updates are made to the records, the same process is used in reverse to store those updates.

In an alternative embodiment, the system of the present invention could be implemented utilizing a smart phone. Thus, the customer need not carry any cards at all to utilize the system of the present invention. This can be accomplished by storing the information necessary on the SIM card of a GSM based cell phone or other memory device for the phone or other personal device. Alternatively, a smart phone itself can be used as a POS port with a smart card reader, thus enabling the user to make payments, transfer money, and undertake most transactions through the smart phone for goods and services.

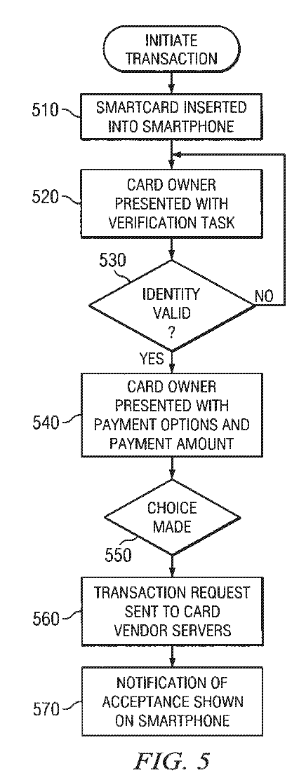

Referring now to FIG. 5, a flowchart showing a process for utilizing a smart phone as a POS port in accordance with an embodiment of the present invention is illustrated. A transaction is initiated by inserting a smart card 510 into a smart phone equipped with a smart card reader. When the card is inserted into the smart phone, the smart phone identifies the card and connects to the vendor's servers via a data connection (HTTP, SHTTP, HTTPS, SSL, VPN, or other IP oriented connection methodology).

Once the connection has been established, the server identifies the smart phone (via its ESN) and associates it with the card (via data transmitted by the smartcard reader). The customer may then be asked to validate his identity 530. Once the customer's identity is validated, the smart phone presents the user with screens allowing the user to select the method of payment and the payment amount 540. For example, the smart card may be associated with numerous payment options on the vendor's servers including debit cards, credit cards, bank transfer, cash value card, and other forms of payment that may be used today or in the future. The customer inputs his or her selection 550.

Once all the required information has been entered and validated, the vendor's servers process the transaction request 560 and upon approval of the request, a notification of acceptance is sent to the smart phone. This system thus enables anyone with a smart phone equipped with a smart card reader to process POS transactions anywhere a data connection is available, opening up opportunities for retailers and reducing the cost of processing POS transactions by eliminating much of the equipment normally required for a retailer to accept such payment methods.

Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A method of fundraising comprising the steps:
providing a card associated with a vendor to a customer for allowing said customer to obtain a discount on a purchase transaction at a participating merchant;
identifying said discount by accessing a database of said vendor using a point of sale terminal;
applying said discount to said purchase;
causing payment in the amount of said discount to be made by said participating merchant directly to a fundraiser after said purchase;
updating said database with a record of said purchase transaction.

2. The method of claim 1 wherein said card allows said customer to make a payment during said purchase transaction without presenting an additional card.

3. The method of claim 2 wherein said card is configured to allow said customer to select a method of payment using said point of sale terminal.

4. The method of claim 3 wherein said method of payment is a credit card payment.

5. The method of claim 1 further comprising the steps:
making a payment from said fundraiser to said vendor for the provision of said card;
making a payment from said customer to said fundraiser in exchange for said card; and
activating said card for use by said customer by providing vendor with an identity of said customer and a unique identifier associated with said card.

6. The method of claim 5 wherein said card is initially dedicated to said fundraiser for a specified length of time, after which time said customer can renew said card and select a different fundraiser if desired by said customer.

7. The method of claim 5 further comprising the step giving said fundraiser access to said server to allow said fundraiser to obtain information regarding said purchase transaction.

8. The method of claim 7 further comprising the step giving said customer access to said server to allow said customer to obtain information regarding said purchase transaction.

9. The method of claim 8 further comprising the step giving said participating merchant access to said server to allow said participating merchant to obtain information regarding said purchase transaction.

10. A fundraising system comprising:
a card for use by a customer;
a point of sale system at a participating merchant capable of reading said card; and
a central database for storing information regarding said customer wherein said central database is accessible by said point of sale system using information obtained from said card by said point of sale system,
wherein responsive to the presentation of said card by said customer to a participating merchant, said point of sale system accesses said central database to determine a discount to be applied to a purchase transaction and wherein said participating merchant pays directly to a charitable organization selected by said customer an amount proportionate to said discount.

11. The fundraising system of claim 10 wherein said card provides additional functionality to said customer other than acting as a discount card.

12. The fundraising system of claim 11 wherein said card also functions to allow payment by said customer from an account selected by said customer.

13. The fundraising system of claim 12 wherein said card comprises credit card information.

14. The fundraising system of claim 12 wherein said point of sale system allows said customer to select a payment method from a plurality of options.

15. The fundraising system of claim 14 wherein said plurality of options are stored on said card.

16. The fundraising system of claim 14 wherein said plurality of options are stored on said central database.

17. The fundraising system of claim 11 wherein said discount card also functions as a key.

18. The fundraising system of claim 11 wherein said discount card also functions as a rewards card.

19. The fundraising system of claim 11 wherein said card is a smart card.

20. The fundraising system of claim 11 wherein said card is integrated into a smart phone.

21. The fundraising system of claim 11 wherein a smart phone is utilized as said point of sale terminal.
